(19) United States
(12) Patent Application Publication
(10) Pub. No.: US 2010/0118678 A1
(43) Pub. Date: May 13, 2010

(54) METHOD FOR TESTING MAGNETIC RECORDING MEDIUM AND METHOD FOR PRODUCTION OF MAGNETIC RECORDING MEDIUM INCLUDING TESTING STEP

(75) Inventors: Yohei Sakano, Ichihara-shi (JP); Koji Tsukada, Ichihara-shi (JP); Yoshikazu Tsukada, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku (JP)

(21) Appl. No.: 12/514,033

(22) PCT Filed: Nov. 9, 2007
(86) PCT No.: PCT/JP2007/072236

§ 371 Date: Jan. 12, 2010

(30) Foreign Application Priority Data
Nov. 13, 2006 (JP) 2006-306472
Jul. 3, 2007 (JP) 2007-174765

(51) Int. Cl. G11B 20/18

(52) U.S. Cl. 369/53.41; G9B/20.046

(57) ABSTRACT

A method for testing a magnetic recording medium tests a magnetic recording medium provided on a non-magnetic substrate (1) with at least a magnetic layer (3) for surface characteristics by using a testing head possessing a heat sensitive element. The method starts from scanning the surface of the magnetic recording medium by using a testing head possessing a heat sensitive element. By this scanning, a signal component of low frequency originating in the swell of the surface of the magnetic recording medium is separated from the signal emitted from the testing head. The protrusion on the surface of the magnetic recording medium is detected from the signal of high frequency remaining after the separation.

### CROSS REFERENCE TO RELATED APPLICATION

This application is an application filed under 35 U.S.C. §111(a) claiming the benefit pursuant to 35 U.S.C. §119(e)(1) of the filing dates of Japanese Patent Applications No. 2006-306472 filed Nov. 13, 2006 and No. 2007-174765 filed Jul. 3, 2007 pursuant to 35 U.S.C. §111(b).

### TECHNICAL FIELD

This invention relates to a method for testing a magnetic recording medium to be used as a magnetic recording and reproduction apparatus, i.e. the so-called hard disk drive, and a method for the production of a magnetic recording medium including a testing step of the testing method.

### BACKGROUND ART

The magnetic recording and reproduction apparatus (hard disk drive) has reached the level of 150 G bits/square inch in recording density. It is said that the recording density will continue to increase at an annual rate of 30% in future. Thus, researches are being promoted toward developing a magnetic recording medium that suits this increase in high recording density.

The magnetic recording medium to be used for the magnetic recording and reproduction apparatus is now being mainly configured by stacking a metal film by the sputtering technique on a substrate intended for use in the magnetic recording medium, forming thereon a protective film, such as a carbon film, and coating the protective film with a perfluoropolyether compound that is a liquid lubricant.

In the process for producing this magnetic recording medium, the application of the liquid lubricant to the magnetic recording medium is followed by a step of testing the surface of the magnetic recording medium for protrusions.

In the magnetic recording and reproduction apparatus using a floating magnetic head for the magnetic recording medium, the magnetic head is driven at a high speed and the dynamic pressure consequently generated between the magnetic head and the magnetic recording medium is utilized for inducing floatation of the magnetic head. Generally the magnetic recording medium is in the shape of a disk and the magnetic head is made to float by rotating the magnetic recording medium at a high speed. Since the number of revolutions reaches 15000 revolutions/minute, the presence of protrusions on the surface of the magnetic recording medium incurs the problem that the magnetic head will contact these protrusions, render difficult normal operation, and possibly inflict damage on itself or the magnetic recording medium. With a view to conforming that the surface of the magnetic recording medium is destitute of such protrusions and other extraneous substances and is flat, the surface is tested for the property called glide height (refer, for example, to JP-A HEI 11-260014 and JP-A HEI 7-326049).

Further, in recent years, the magnetic disk drive using a magnetoresistive head (MR head) has been proposed. In consequence of densification of the magnetic recoding medium, the amount of floatation of the MR head from the magnetic recording medium has been decreasing. As a result, the MR head collides against the protrusions that form a fault inevitably existing on the magnetic recording medium and the frictional heat consequently generated induces a variation of the value of resistance attendant on the rise of temperature of the magnetic signal reading element of the MR head. This variation entails the phenomenon of varying the waveform of the magnetic signal regenerated by the MR head, namely the problem of thermal asperity. As a way of rating the magnetic recording medium for the surface characteristics, a method of adopting a testing head provided with a heat sensitive element and making use of the signal induced by the thermal asperity of a testing head is employed (refer, for example, JP-A HEI 10-105908). The term “heat-sensitive element” as used in this invention refers to the changing of physical properties, such as the value of resistance of the element attendant on the increase of temperature of the element. The observation of such changes of physical properties enables the heat sensitive element to detect the occurrence of heat. The MR element, i.e. an element for reading the magnetic signal of the MR head, can be used as a heat sensitive element.

The density growth of the magnetic recording medium has been further advancing and the space between the magnetic recoding medium and the head has been further decreasing. As a result, the evaluation of the surface characteristics of the magnetic recording medium by the use of a testing head possessing a heat sensitive element has been further gaining in rigidity.

In the evaluation of the magnetic recording medium by the use of the testing head possessing a heat sensitive element, the amount of floatation to be used is lower than when the MR head is actually used in the hard disk drive. Thus, the testing head possessing the heat sensitive element emits the signal not originating in the protrusions on the surface of the magnetic recording medium as a noise. The noise entails the problem that this signal will bury the signal originating in the protrusions and consequently impede accurate detection of the protrusions on the surface of the magnetic recording medium. Of the protrusions on the surface of the magnetic recording medium, particularly fine protrusions that bury in the noise and escape detection entail the problem of degrading the reliability of the magnetic recording medium.

This invention is aimed at solving this problem so as to provide a method for testing the magnetic recording medium with high accuracy capable of enabling detection of such fine protrusions.

This inventors have performed a diligent study with a view to clarifying the cause for this problem and has consequently found that the noise included in the signal emitted from the testing head possessing a heat sensitive element is actually not a simple noise but is caused by the swell formed on the surface of the magnetic recording medium, that the swell, though not contacting the testing head which is used for testing the magnetic recording medium and which possesses a heat sensitive element, causes the testing head possessing the heat sensitive element to emit a signal, and that the fine protrusions on the surface of the magnetic recording medium can be detected by separating the signal originating in the swell from the signal issued from the testing head possessing the heat sensitive element. This invention has been consequently perfected.

### DISCLOSURE OF THE INVENTION

The present invention provides as the first aspect thereof a method for testing a magnetic recording medium provided on a nonmagnetic substrate with at least a magnetic layer for surface characteristics by the use of a testing head possessing a heat sensitive element, comprising the steps of scanning a surface of the magnetic recording medium with a testing head possessing a heat sensitive element, separating a signal of low frequency originating in swell on the surface of the magnetic recording medium from the signal emitted from the testing head, and detecting protrusions on the surface of the magnetic recording medium from a signal of high frequency remaining after the separating step.

In the second aspect of the invention that includes the method of the first aspect, the signal of low frequency has a wavelength of 40 μm or more.

The invention also provides as the third aspect thereof a method for testing a magnetic recording medium provided on a nonmagnetic substrate with at least a magnetic layer for surface characteristics by the use of a testing head possessing a heat sensitive element, comprising the steps of scanning a surface of the magnetic recording medium with a testing head possessing a heat sensitive element, separating a signal of low frequency originating in a factor other than swell from the signal emitted from the testing head, and detecting protrusions on the surface of the magnetic recording medium from a signal of high frequency remaining after the separating step.

The invention further provides as the fourth aspect thereof a method for testing a magnetic recording medium provided on a nonmagnetic substrate with at least a magnetic layer for surface characteristics by the use of a testing head possessing a heat sensitive element, comprising the steps of scanning a surface of the magnetic recording medium with a testing head possessing a heat sensitive element, separating a signal of low frequency originating in swell on the surface of the magnetic recording medium or a signal of low frequency originating in a factor other than the swell from a signal emitted from the testing head, detecting protrusions on the surface of the magnetic recording medium from a signal of high frequency remaining after the separating step, and excluding a magnetic recording medium containing protrusions having a prescribed height as a reject.

The invention additionally provides as the fifth aspect thereof a method for testing a magnetic recording medium provided on a nonmagnetic substrate with at least a magnetic layer for surface characteristics by the use of a testing head possessing a heat sensitive element, comprising the steps of scanning a surface of the magnetic recording medium with a testing head possessing a heat sensitive element, separating a signal originating in collision of a colliding article against the surface of the magnetic recording medium or a signal of high frequency from a signal emitted from the testing head, detecting swell on the surface of the magnetic recoding medium from a signal of low frequency remaining after the separating step, and excluding a magnetic recording medium containing swell exceeding a prescribed level as a reject.

In the sixth aspect of the invention that includes the method of the first aspect, the separating step and detecting step are performed using a bandpass filter or a highpass filter and the detecting step is performed using a bandpass filter or a lowpass filter.

In the seventh aspect of the invention that includes the method of the third aspect, the separating step detecting step are performed using a bandpass filter or a highpass filter and the detecting step is performed using a bandpass filter or a lowpass filter.

In the eighth aspect of the invention that includes the method of the fifth aspect, the separating step and detecting step are performed using a bandpass filter or a lowpass filter.

The invention further provides as the ninth aspect thereof a method for the production of a magnetic recording medium provided on a non-magnetic substrate with at least a magnetic layer, wherein the method includes the testing method of the first aspect.

This invention, in connection with the magnetic recording medium to be used as in the magnetic recording and reproduction method, is directed to providing a method for testing the magnetic recording medium that is capable of detecting such protrusions and swells as the conventional evaluation for surface characteristics has failed to detect. This fact has an effect of rendering possible provision of a method for the production of a magnetic recording medium of high reliability.

The above and other objects, characteristic features and advantages of the present invention will become apparent to those skilled in the art from the description to be given herein below with reference to the accompanying drawings.

### BRIEF DESCRIPTION OF THE DRAWINGS

FIG. 1 is a schematic view illustrating the sectional structure of a magnetic recoding medium of this invention.

FIG. 2 is a schematic view illustrating the structure of a magnetic recording and reproduction apparatus of this invention.

FIG. 3 is a diagram illustrating the relation between the lower limit value and the S/N ratio of a bandpass filter.

FIG. 4 is a diagram illustrating the relation between the lower limit value of a bandpass filter and the size and height of detectable protrusions.

### BEST MODE FOR CARRYING OUT THE INVENTION

This invention is directed to a method for testing a magnetic recording medium provided on a non-magnetic substrate with at least a magnetic layer for the surface characteristics of the medium by using a testing head possessing a heat sensitive element. The method comprises the steps of scanning the surface of the magnetic recording medium with a testing head possessing a heat sensitive element, separating a signal of low frequency originating in the swell on the surface of the magnetic recording medium from the signal emitted from the testing head, and detecting protrusions on the surface of the magnetic recording medium from a signal of high frequency remaining after the separation.

The MR head is characterized by the fact that it possesses high sensitivity as compared with the conventional inductive head and enables the recording density to be heightened to 5 to 10 times. The MR head, on the other hand, is at a disadvantage in being sensitive to heat and varying its value of resistance in proportion as the temperature is increased. When the head contacts a protrusion existing on the magnetic recording medium in motion at a high speed during the course of reproduction, therefore, it instantaneously generates heat to increase the value of resistance of the MR element, vary the output voltage level of the reproduced signal, and render the magnetic signal difficult to read. This phenomenon is called “thermal asperity.” The method for testing the surface characteristics according to this invention is directed to detecting the thermal asperity by using a testing head possessing a heat sensitive element and examining the magnetic recording medium for protrusions formed on its surface.

Now, a preferred embodiment of this invention will be described below with reference to the accompanying drawings.

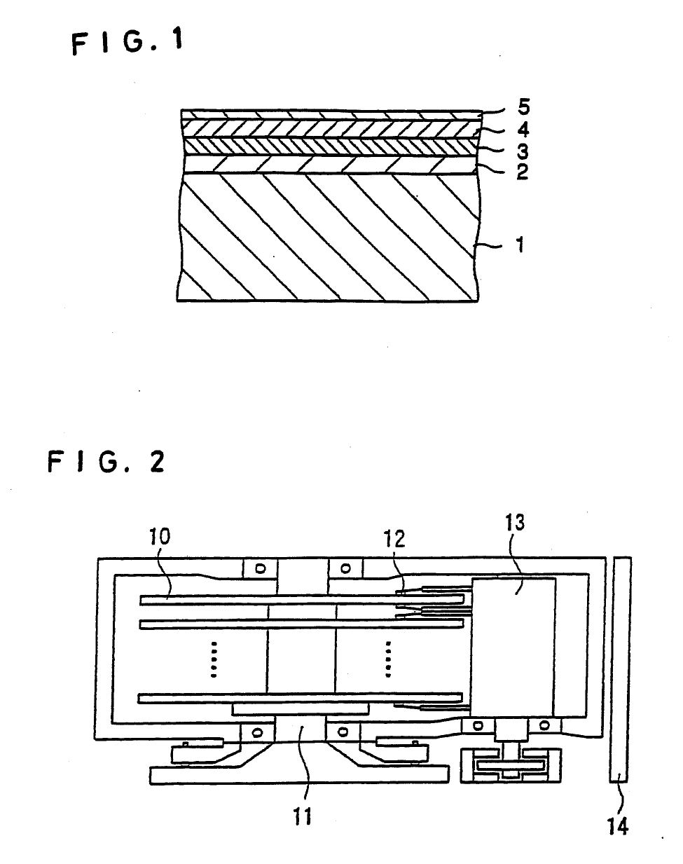

FIG. 1 illustrates a preferred embodiment of a magnetic recoding medium to which this invention pertains. The magnetic recording medium shown in the drawing results from stacking a non-magnetic under layer 2, a magnetic layer 3, a protective layer 4 and a liquid lubricant layer 5 sequentially on a non-magnetic substrate 1.

As the non-magnetic substrate 1 to which this invention relates, what is obtained by having a film of NiP or NiP alloy formed on a substrate made of a metallic material, such as Al or Al alloy, can be used. The non-magnetic substrate 1 that is made of a non-metallic material, such as glass, ceramic, silicon, silicon carbide, carbon or resin, may be used. What results from having a film of NiP or NiP alloy formed on a substrate made of a non-metallic material may be used.

As the non-metallic material, one kind selected from the group consisting of glass and silicon proves advantageous from the viewpoint of surface smoothness. It is particularly favorable to use glass in terms of cost and durability. As the glass, crystallized glass or amorphous glass may be used. As the amorphous glass, general-purpose soda lime glass, aluminoborophosphate glass and aluminosilicate glass may be used. As the crystallized glass, a lithium-based crystallized glass may be used.

As the materials for the ceramic substrate, general-purpose aluminum oxide, sinters having silicon nitride as a main component, and fiber-reinforced articles thereof may be cited. For the purpose of heightening recording density, the magnetic head is required to meet the trend toward lowering flying height and the non-magnetic substrate 1 is required to heighten its surface smoothness. To be specific, the non-magnetic substrate 1 is required to have average surface roughness Ra of 0.5 nm or less, preferably 0.3 nm or less.

On the non-magnetic substrate, the non-magnetic under layer 2 is formed. Cr alloy, for example, is used for the non-magnetic under layer 2.

As the materials for the magnetic layer 3 in this invention, Co—Cr—Ta-based, Co—Cr—Pt-based, Co—Cr—Pt—Ta-based and Co—Cr—Pt—B—Ta-based alloys are used.

For the protective layer 4 in this invention, simple substances, such as carbon and SiC and materials having them as main components, can be used. The thickness of the protective layer 4 limited in the range of 1 nm to 10 nm proves advantageous from the viewpoint of reducing the magnetic spacing in the case of use under the condition of high recording density and enhancing the durability. The term “magnetic spacing” used herein means the distance from the read/write element of the magnetic head and the magnetic layer 3. The electromagnetic conversion characteristic is enhanced in accordance as the magnetic spacing decreases.

In this invention, the liquid lubricant layer 5 is formed on the protective layer. The thickness of the liquid lubricant layer of this invention prefers to be in the range of 1.5 nm to 2.5 nm. As the liquid lubricant, a perfluoropolyether compound is used, for example.

This invention, in evaluating the surface characteristics, uses the testing head possessing a heat sensitive element to measure the frictional heat generated during the collision of a protrusion on the surface of the magnetic recording medium against the testing head, detect thermal asperity, i.e. the phenomenon of variation of the signal waveform reproduced by the testing head, and evaluate the flatness and smoothness of the surface of the magnetic recording medium from the resultant signal.

The testing head possessing the heat sensitive element in this case is used with a low amount of floatation as compared with the conditions of use of the MR head within an ordinary hard disk drive. Besides the signal originating in the collision of the surface of the magnetic recording medium against a large protrusion, emission of signal of a low level of amplitude has been known. This signal of the low level of amplitude has been considered as a device noise generated by the testing head possessing a heat sensitive element, the amplifier, and the like. As a result, the detector has not been allowed to lower its threshold voltage and has been unable to detect the signal of low level due to collision of a small protrusion against the testing head possessing a heat sensitive element.

The present inventors, however, have found that the signal heretofore considered as the device noise includes a component originating in the swell of the surface of the magnetic recording medium. The signal due to the swell is emitted without inducing contact with the testing head. Though the reason for the emission of this signal has not been elucidated, the present inventors offer an explanation based on the supposition that the transfer of heat via the intervening air between the testing head possessing a heat sensitive element and the surface of the magnetic recording medium results in varying the temperature of the heat sensitive element and inducing the emission.

The present inventors, in the process of testing the magnetic recording medium possessing a heat sensitive element, has made it possible by excluding the frequency component computed from the swell of the surface of the magnetic recording medium from the signal emitted from the testing head to detect the signal originating in a minute protrusion on the surface of the magnetic recording medium besides the conventionally detected signal originating in a large protrusion on the surface of the magnetic recoding medium. The signal originating in the minute protrusion on the surface of the magnetic recording medium has heretofore been unduly underestimated because it is buried in the noise during the conventional course of testing. The hard disk drive that has incorporated a magnetic recording medium passing this testing, therefore, has the possibility that the head contacts the minute protrusion on the surface of the magnetic recording medium and induces a head crush or the like.

Thus, this invention is directed to a method for testing a magnetic recording medium provided on a non-magnetic substrate with at least a magnetic layer, a protecting layer, and a liquid lubricant layer for surface characteristics by using a testing head possessing a heat sensitive element. The method is essentially directed to detecting the protrusion on the surface of the magnetic recording medium with as high accuracy as possible by scanning the surface of the magnetic recording medium, separating a signal originating in the swell of the surface of the magnetic recording medium from the signal emitted from the testing head possessing the heat sensitive element, and detecting the protrusion on the surface of the magnetic recording medium based on the signal remaining after the separation.

Thus, this invention is directed to a method for testing a magnetic recording medium provided on a non-magnetic substrate with at least a magnetic layer, a protecting layer, and a liquid lubricant layer for surface characteristics by using a testing head possessing a heat sensitive element. The method essentially comprises detecting the protrusion on the surface of the magnetic recording medium with as high accuracy as possible by scanning the surface of the magnetic recording medium, separating a signal originating in the swell of the surface of the magnetic recording medium from the signal emitted from the testing head possessing the heat sensitive element, and detecting the swell on the surface of the magnetic recording medium from the signal originating in the separated swell.

The expression “swell on the surface of the magnetic recording medium” as used in this invention refers to a gently sloping undulation having a comparatively long wavelength (low frequency) in the range exceeding 40 μm. The high-level magnetic recording medium having such a gently sloping undulation of such a long wavelength is considered to arise as during the process of production of a substrate for use in the magnetic recoding medium.

The undulation (swell) of such a long wavelength formed on the surface of the magnetic recording medium has caused no particular problem because the head follows this undulation. Since the density growth of the magnetic recording medium has been further advancing and the space between the magnetic recording medium and the head has been further decreasing, however, it is assumed that the swell that has never posed any problem has appeared as a signal in the process of testing by the use of a testing head possessing a heat sensitive element.

Here, the signal originating in the swell on the surface of the magnetic recording medium and detected by the testing head possessing a heat sensitive element is such that the frequency f of the signal originating in the swell exceeding the wavelength λ formed on the surface of the magnetic recording medium satisfies this relation, f=V/λ, wherein V denotes the magnitude of the peripheral velocity of the magnetic recording medium and the testing head possessing a heat sensitive element during the course of the test. On the assumption of V=15 m/sec, the frequency f of the signal originating in the swell having a wavelength λ of 40 μm or more and formed on the surface of this magnetic recording medium is computed to be 375 kHz or less. When the protrusion on the surface of the magnetic recording medium contacts the testing head possessing the heat sensitive element, the signal emitted from the testing head possessing the heat sensitive element is such that its rising time from the base line to the peak is about 400 ns, though depending on the characteristics of the testing head possessing the heat sensitive element. This signal in terms of frequency is computed from the reciprocal of the length of the signal to be a high frequency of 600 kHz, a large frequency as compared with the components of the signal originating in the swell.

In the method for testing the magnetic recording medium by using the testing head possessing the heat sensitive element, it is made possible by separating with a highpass filter or a bandpass filter the signal component of low frequency originating in the swell of the surface of the magnetic recording medium from the signal emitted from the testing head possessing the heat sensitive element, to detect the signal, such as a signal exceeding 400 kHz, richly containing components originating in the protrusion on the surface of the magnetic recoding medium based on the signal of high frequency remaining after the separation and to detect selectively the signal due to the collision of a matter against the surface of the magnetic recording medium. As a result, of the conventional signal component, the signal originating in a minute protrusion hidden by the signal level of a frequency falling short of 400 kHz can be clearly detected.

This invention can be applied to the noise signal of a specific frequency other than the signal due to the swell. For example, when the noise signal as from the head, amplifier or the like allows the presence of a signal having a frequency falling short of 400 kHz, it is made possible by separating this signal to detect the minute protrusion from the signal remaining after the separation.

In the detection of the protrusion, the magnetic recording medium containing a protrusion having a specific height, such as a height of 6 nm or more, can be excluded as a reject.

By using this method for testing the magnetic recording medium, it is made possible to provide the magnetic recording medium that exhibits higher reliability than attained heretofore.

Further, in the method for testing the magnetic recording medium by using the testing head possessing the heat sensitive element, it is made possible by separating the signal component, such as a signal of frequency falling short of 200 kHz originating in the swell of the surface of the magnetic recording medium, from the signal emitted from the testing head possessing the heat sensitive element to detect a magnetic recording medium generating a large swell from the consequently separated signal of low frequency. This invention uses this signal to evaluate the swell formed on the surface of the magnetic recording medium and detect and exclude as a reject the magnetic recording medium containing swell of such level as poses the problem that the MR head incurs difficulty in following the swell within the hard disk drive. In the case of noise resembling this swell, it can be discerned by the reproducibility of a signal.

FIG. 2 illustrates one example of the magnetic recording and reproduction apparatus using the magnetic recording medium mentioned above. The magnetic recording and reproduction apparatus illustrated here is provided with a magnetic recording medium 10 configured as described above, a recording medium drive part 11 for rotationally driving the magnetic recording medium 10, a magnetic head 12 for recording and reproducing information in the magnetic recording medium 10, a head drive part 13 for causing the magnetic head 12 to be moved relative to the magnetic recording medium 10, and a recording and reproducing signal processing system 14. The recording and reproducing signal processing system 14 is adapted to process data entered from the exterior and send the recording signal to the magnetic head 12 or process the reproduced signal from the magnetic head 12 and send the resultant signal to the exterior.

As the magnetic head 12, a head provided with not only a magnetoresistive (MR) element utilizing a giant magnetoresistance (GMR) effect as a reproduced element, but also a tunnel magnetoresistance (TMR) element utilizing the TMR effect and made to fit high recording density can be used. The use of the TMR element enables further addition to high recording density.

Now, the method for testing the magnetic recording medium of this invention and the effect of the method for producing the magnetic recording medium containing the testing method will be described clearly with reference to an example.

### Example 1-1

For the non-magnetic substrate, an amorphous glass substrate made by HOYA Corporation was used. This glass substrate measured 65 mm in outside diameter, 25 mm in inside diameter and 1.270 mm in plate thickness.

This substrate was textured, washed thoroughly and dried, and set in a DC magnetron sputtering device (made by Anelva (Japan) Corporation and sold under the trade name of “C3010”). The device was evacuated till a vacuum of 2×10⁻⁷ Torr (2.7×10⁻⁵ Pa) and Cr—Mn alloy (Cr: 70 at % and Mn: 30 at %) was stacked thereon in a thickness of 6 nm as a non-magnetic under layer by using a target of this alloy. By using a target made of Co—Cr—Pt—B alloy (Co: 60 at %, Cr: 20 at %, Pt: 13 at % and B: 7 at %), a Co—Cr—Pt—B alloy layer was formed in a film thickness of 17 nm as a magnetic layer, followed by stacking of a protective film (carbon) in a thickness of 3 nm. The Ar pressure during the film formation was set at 3 mTorr (0.4 Pa). Subsequently, a lubricant of perfluoropolyether was applied in a thickness of 2 nm by the dipping method to form the liquid lubricant layer.

Prior to being tested for the surface characteristics by the use of the testing head possessing a heat sensitive element, the magnetic recording media obtained as above were subjected to the test with a glide tester using a head provided with a piezoelectric element to expel such magnetic recording media containing large protrusions. The glide height. (the distance between the head and the magnetic recording medium) of the head was set at 0.25 pinch.

A total of 100 magnetic recording media that had passed the test described above were subjected to the glide test to determine the surface characteristics using a testing head possessing a heat sensitive element. As regards the conditions of this test, the glide height was set at 0.22 μinch, the slice level (the threshold level used during the scanning of the surface of a given magnetic recording medium by the use of the testing head possessing the heat sensitive element to find the medium as rejectable based on the signal emitted by the protrusion in response to the output from the testing head possessing the heat sensitive element) was set 56% of the signal emitted when the head used in the evaluation collided with a protrusion of 0.25 μinch, and the bias current of the heat sensitive element was set at 14.5 mA. The signal from the testing head possessing the heat sensitive element was passed through a bandpass filter of 100 kHz to 3000 kHz by way of evaluation. As the result of this evaluation, six of the 100 magnetic recording media were observed to possess output signals exceeding the slice level.

### Example 1-2

The six magnetic recording media that had been observed to have output signals exceeding the slice level were evaluated herein. The evaluating conditions of Example 1-1 were further rigidified herein by setting the glide height at 0.19 μinch and the slide level at 40%. The bandpass filter was set at 400 kHz to 3000 kHz. The six magnetic recording media were invariably found to have the output signals from the testing head possessing the heat sensitive element falling below the slice level. The signals emitted from the magnetic recording media in Example 1-1 and exceeding the slice level were invariably thought to originate in the swell on the surface of the magnetic recording medium and the magnitudes of these swells were thought to be on the level capable of being followed by the testing head possessing the heat sensitive element. The results indicate that it is made possible by increasing the lower limit of the bandpass filter from 100 kHz to 400 kHz to decrease the signal of the swell component from the testing head possessing the heat sensitive element and it is consequently rendered possible to further rigidify the testing conditions by lowering the slice level and the glide height in the evaluation using the testing head possessing the heat sensitive element.

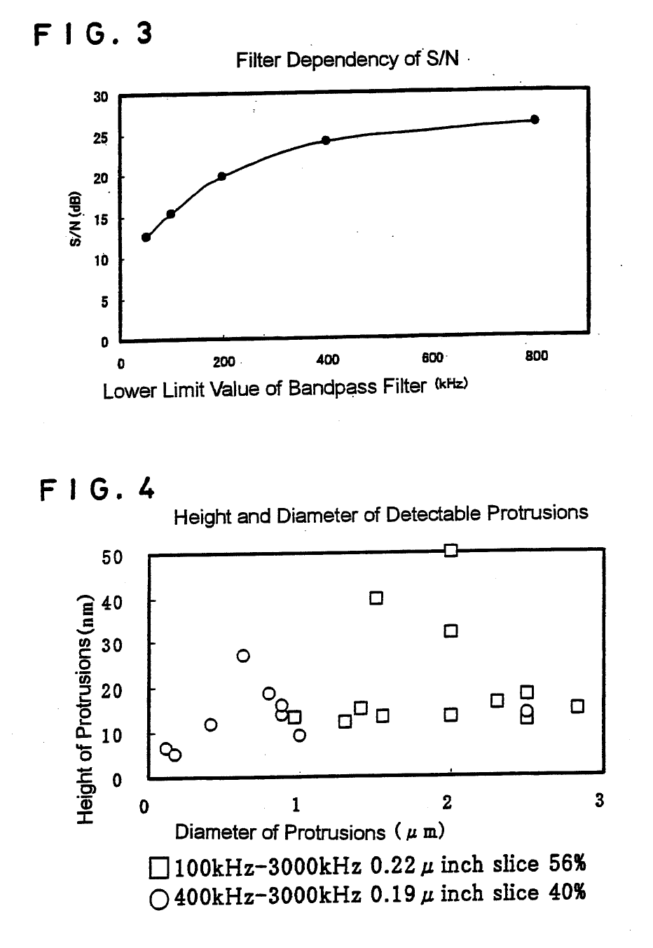

FIG. 3 illustrates the relation between the lower limit of the bandpass filter and the S/N ratio with respect to the signal emitted from the testing head possessing a heat sensitive element. The noise of the signal emitted from the testing head possessing the heat sensitive element is due mainly to the swell (exclusion) of the surface of the magnetic recording medium. The results indicate that evaluation of the heightened S/N ratio is achieved by removing with a bandpass filter the swell component from the signal emitted from the testing head possessing a heat sensitive element. By using a bandpass filter of 50 kHz to 200 kHz, for example, it is made possible to selectively detect the swell alone.

FIG. 4 shows the height and the diameter of a detectable protrusion on the surface of the magnetic recording medium in the evaluation under the conditions of Examples 1-1 and 1-2. The height and the diameter of the protrusion were obtained by measuring with AFM the surface of the magnetic recording medium after the evaluation. The results indicate that the height and the diameter of the detectable protrusion could be decreased by removing with a bandpass filter the swell component from the signal emitted from the magnetic recording medium possessing a heat sensitive element.

### INDUSTRIAL APPLICABILITY

By the testing method of this invention, the magnetic recording medium can be tested for such fine protrusions and swells as have never been evaluated by the conventional technique. This invention, therefore, enables provision of products of further added reliability and proves highly useful for the industry.

1. A method for testing a magnetic recording medium provided on a nonmagnetic substrate with at least a magnetic layer for surface characteristics by the use of a testing head possessing a heat sensitive element, comprising the steps of:
scanning a surface of the magnetic recording medium with a testing head possessing a heat sensitive element;
separating a signal of low frequency originating in swell on the surface of the magnetic recording medium from the signal emitted from the testing head; and
detecting protrusions on the surface of the magnetic recording medium from a signal of high frequency remaining after the separating step.

2. A method for testing the magnetic recording medium according to claim 1, wherein the signal of low frequency has a wavelength of 40 μm or more.

3. A method for testing a magnetic recording medium provided on a nonmagnetic substrate with at least a magnetic layer for surface characteristics by the use of a testing head possessing a heat sensitive element, comprising the steps of:
scanning a surface of the magnetic recording medium with a testing head possessing a heat sensitive element;
separating a signal of low frequency originating in a factor other than swell from the signal emitted from the testing head; and
detecting protrusions on the surface of the magnetic recording medium from a signal of high frequency remaining after the separating step.

4. A method for testing a magnetic recording medium provided on a nonmagnetic substrate with at least a magnetic layer for surface characteristics by the use of a testing head possessing a heat sensitive element, comprising the steps of:
scanning a surface of the magnetic recording medium with a testing head possessing a heat sensitive element;
separating a signal of low frequency originating in swell on the surface of the magnetic recording medium or a signal of low frequency originating in a factor other than the swell from a signal emitted from the testing head;
detecting protrusions on the surface of the magnetic recording medium from a signal of high frequency remaining after the separating step; and
excluding a magnetic recording medium containing protrusions having a prescribed height as a reject.

5. A magnetic recording medium provided on a nonmagnetic substrate with at least a magnetic layer for surface characteristics by the use of a testing head possessing a heat sensitive element, comprising the steps of:
scanning a surface of the magnetic recording medium with a testing head possessing a heat sensitive element;
separating a signal originating in collision of a colliding article against the surface of the magnetic recording medium or a signal of high frequency from a signal emitted from the testing head;
detecting swell on the surface of the magnetic recoding medium from a signal of low frequency remaining after the separating step; and
excluding a magnetic recording medium containing swell exceeding a prescribed level as a reject.

6. A method for testing a magnetic recording medium according to claim 1, the separating step and detecting step are performed using a bandpass filter or a highpass filter.

7. A method for testing a magnetic recording medium according to claim 3, the separating step and detecting step are performed using a bandpass filter or a highpass filter.

8. A method for testing a magnetic recording medium according to claim 5, the separating step and detecting step are performed using a bandpass filter or a lowpass filter.

9. A method for the production of a magnetic recording medium provided on a non-magnetic substrate with at least a magnetic layer, wherein the method includes the testing method according to claim 1.
